(19) United States
(12) Patent Application Publication
(10) Pub. No.: US 2023/0138248 A1
(43) Pub. Date: May 4, 2023

(54) Antistatic or dust-repellent poly(methyl methacrylate) composition

(71) Applicant: ARKEMA FRANCE, Colombes (FR)

(72) Inventors: Clio COCQUET, Serquigny (FR); Cédric ROY, Serquigny (FR); Sylvain QUERUEL, Serquigny (FR); Alejandra REYNA-VALENCIA, Serquigny (FR)

(73) Assignee: ARKEMA FRANCE, Colombes (FR)

(21) Appl. No.: 17/917,785

(22) PCT Filed: Apr. 12, 2021
(86) PCT No.: PCT/FR2021/050641

§ 371 Date: Oct. 7, 2022

(30) Foreign Application Priority Data
Apr. 10, 2020 (FR) FR2003632

(51) Int. Cl. C08L 33/12

(52) U.S. Cl. CPC C08L 33/12; C08L 2201/04

(57) ABSTRACT

A poly(methyl methacrylate) composition and to the uses of the composition. The composition includes 85 to 98% by weight, relative to the weight of the composition, of poly(methyl methacrylate) having a loss factor tan δ of at least 10; and 2 to 15% by weight, relative to the weight of the composition, of copolymer including polyamide blocks and polyether blocks.

### FIELD OF THE INVENTION

The present invention relates to a composition based on poly(methyl methacrylate) and also to the uses of said composition.

### TECHNICAL BACKGROUND

The formation and retention of static electricity charges on the surface of most plastics is known. In the case of poly(methyl methacrylate) (PMMA), notably during the transport of PMMA granules, the formation of static electricity on the PMMA granules leads to the granules sticking together (making it difficult to separate them), and to then forming a block, which makes the unloading of the granules problematic, for example. The presence of static electricity on transparent PMMA objects can cause dust to accumulate on these objects and thus hamper their use and detract from their esthetic appearance. In industry, residual PMMA powder also tends to stick to machined parts. The accumulation of dust on the surface of these objects alters their transparency.

Antistatic agents such as ionic surfactants of the ethoxylated amine or sulfonate type that are added to polymers have been described in the prior art. However, the antistatic properties of polymers depend on the ambient humidity and they are not permanent since these agents migrate to the surface of the polymers and disappear. Hydrophilic copolymers containing polyamide blocks and polyether blocks were then proposed as antistatic agents. These agents have the advantage of not migrating and thus of giving permanent antistatic properties that are moreover independent of the ambient humidity.

EP 2 984 137 relates to a transparent antistatic poly(methyl methacrylate) (PMMA) composition comprising, relative to the total weight of the composition: from 55% to 99.9% by weight of PMMA; and from 0.1% to 45% by weight of at least one PEBA copolymer containing polyamide PA blocks and polyether PE blocks comprising polyethylene glycol (PEG), in which said copolymer is characterized in that it comprises from 50% to 80% by weight of PEG relative to the total weight of the copolymer.

There is a need to provide a composition based on poly(methyl methacrylate), having at the same time good antistatic or dust repellency properties and also good mechanical properties, and good transparency properties.

### SUMMARY OF THE INVENTION

The invention relates firstly to a composition comprising:
from 85% to 98% by weight of poly(methyl methacrylate), relative to the weight of the composition, the poly(methyl methacrylate) having a loss factor tan δ, which is the ratio of the moduli G″ and G′ measured at a temperature of 220° C. and an angular frequency of 1 rad/sec, greater than or equal to 10;

and
from 2% to 15% by weight of copolymer containing polyamide blocks and polyether blocks, relative to the weight of the composition.

The present invention meets the need expressed above. More particularly, it provides a composition based on poly(methyl methacrylate), having at the same time good antistatic or dust repellency properties and also good mechanical properties, and good transparency properties.

This is accomplished by means of combining poly(methyl methacrylate) in a content of 85% to 98% by weight relative to the weight of the composition, the poly(methyl methacrylate) having melt viscoelastic properties characterized by a loss factor tan δ of greater than or equal to 10, and at least one copolymer containing polyamide blocks and polyether blocks in a content of 2% to 15% by weight relative to the total weight of the composition. More particularly, it has been found that such compositions have both good antistatic or dust repellency properties, and good mechanical properties (impact strength, Vicat point, etc.), notably relative to compositions consisting of PMMA or to compositions with a loss factor tan δ outside the claimed range.

### DETAILED DESCRIPTION

The invention is now described in greater detail and in a nonlimiting manner in the description that follows.

The composition according to the invention is preferably a transparent composition.

The term “transparent composition” means a composition with a transmittance of at least 88% according to the standard ASTM D1003-97/ISO 13468, and a haze (turbidity or cloudiness) of less than 15%, preferably less than 10%, preferably less than 5%, according to the standard ASTM D1003-97, these two properties being measured at 560 nm on a 2 mm thick plate.

The term “antistatic composition” means a composition whose surface resistivity is less than 10¹² ohm/m² measured and greater than 10⁹ ohm/m² according to the standard ASTM D257.

The term “dust-repellent composition” means a composition whose surface resistivity is greater than 10¹² ohm/m², and less than 10¹³ ohm/m² measured according to the standard ASTM D257.

Composition

The transparent composition according to the invention comprises poly(methyl methacrylate) (PMMA).

The term “PMMA” denotes a methyl methacrylate (MMA) homopolymer or copolymer or mixtures thereof.

PMMA is present in the transparent composition in a content ranging from 85% to 98% by weight relative to the weight of the composition. For example, PMMA may be present in the composition in a content of from 85% to 88%; or from 88% to 90%; or from 90% to 92%; or from 92% to 94%; or from 94% to 96%; or from 96% to 98% by weight relative to the weight of the composition.

According to certain embodiments, the PMMA comprises an MMA copolymer.

According to other embodiments, the PMMA is a mixture of at least one homopolymer and at least one copolymer of MMA, or a mixture of at least two copolymers of MMA with a different average molar mass, or a mixture of at least two copolymers of MMA with a different monomer composition.

The MMA copolymer may comprise from 60% to 99.7% by weight of methyl methacrylate and from 0.3% to 40% by weight of at least one monomer containing at least one ethylenic unsaturation that can copolymerize with methyl methacrylate. Preferably, the MMA copolymer may comprise from 70% to 99%, advantageously from 90% to 95% and more advantageously from 70% to 90%, preferably from 80% to 90%, or from 85% to 90% by weight of methyl methacrylate and from 1% to 30%, advantageously from 5% to 30% and more advantageously from 10% to 30% by weight of at least one monomer, containing at least one ethylenic unsaturation, that can copolymerize with methyl methacrylate.

Preferably, this monomer containing at least one ethylenic unsaturation that can copolymerize with methyl methacrylate is a (meth)acrylic monomer. The (meth)acrylic monomer is chosen from acrylic acid, methacrylic acid, alkyl acrylic monomers, alkyl methacrylic monomers and mixtures thereof.

Preferably, the monomer is chosen from acrylic acid, methacrylic acid, alkyl acrylic monomers, alkyl methacrylic monomers and mixtures thereof, the alkyl group containing from 1 to 22 carbon atoms and being linear, branched or cyclic; the alkyl group preferably containing from 1 to 12 carbon atoms and being linear, branched or cyclic. More preferably, the (meth)acrylic monomer is chosen from ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate and isobornyl methacrylate, and mixtures thereof.

Advantageously, the (meth)acrylic monomer is chosen from alkyl (meth)acrylates in which the alkyl group contains from 1 to 12 carbon atoms. As examples, mention may be made of methyl acrylate and ethyl, butyl or 2-ethylhexyl (meth)acrylate. Preferably, the comonomer is an alkyl acrylate in which the alkyl group comprises from 1 to 4 carbon atoms.

More advantageously, the (meth)acrylic monomer is chosen from methyl methacrylate, methyl acrylate and ethyl acrylate, and/or mixtures thereof.

The PMMA included in the composition according to the invention may have a weight-average molar mass of from 70 000 g/mol to 160 000 g/mol, and preferably from 70 000 to 100 000 g/mol.

The weight-average molar mass is measured by size exclusion chromatography using PMMA as calibration standard. The PMMA polymer is dissolved in hexafluoroisopropanol stabilized with 0.05 M potassium trifluoroacetate at a concentration of 1 g/L before being passed through the modified silica columns, for example at a flow rate of 1 mL/min, the mass being measured by refractive index.

Furthermore, the PMMA included in the composition according to the invention has melt viscoelastic properties characterized by a loss factor tan δ of greater than or equal to 10, preferably greater than or equal to 11, more preferably greater than or equal to 12, even more preferentially greater than or equal to 15. The PMMA may notably have a loss factor tan δ of 10 to 15; or 15 to 20; or 20 to 25; or 25 to 30; or 30 to 35; or 35 to 40; or greater than 40. The loss factor tan δ is the ratio of the moduli G″ and G′ measured at a temperature of 220° C. and at an angular frequency of 1 rad/sec. The modulus G′, called the “storage modulus”, characterizes the elastic behavior of the material (the energy stored and fully restored by the material). The modulus G″, called the “loss modulus or dissipation modulus”, characterizes the viscous behavior of the material (the energy dissipated in the form of heat). These rheological properties are measured using a parallel plate oscillatory rheometer, according to the standard ISO 6721-10:2015.

The composition according to the invention also comprises at least one copolymer containing polyamide blocks and polyether blocks.

The copolymers containing polyether blocks and polyamide blocks (abbreviated as “PEBA”) result from the polycondensation of polyamide blocks bearing reactive ends with polyether blocks bearing reactive ends, such as, inter alia:

1) polyamide blocks bearing diamine chain ends with polyoxyalkylene blocks bearing dicarboxylic chain ends;
2) polyamide blocks bearing dicarboxylic chain ends with polyoxyalkylene blocks bearing diamine chain ends, obtained, for example, by cyanoethylation and hydrogenation of α,ω-dihydroxylated aliphatic polyoxyalkylene blocks, known as polyetherdiols;
3) polyamide blocks bearing dicarboxylic chain ends with polyetherdiols, the products obtained being, in this particular case, polyetheresteramides.

The polyamide blocks bearing dicarboxylic chain ends originate, for example, from the condensation of polyamide precursors in the presence of a chain-limiting dicarboxylic acid. The polyamide blocks bearing diamine chain ends originate, for example, from the condensation of polyamide precursors in the presence of a chain-limiting diamine.

The polymers bearing polyamide blocks and polyether blocks may also comprise randomly distributed units.

Three types of polyamide blocks may advantageously be used.

According to a first type, the polyamide blocks originate from the condensation of a dicarboxylic acid, in particular those containing from 4 to 20 carbon atoms, preferably those containing from 6 to 18 carbon atoms, and of an aliphatic or aromatic diamine, in particular those containing from 2 to 20 carbon atoms, preferably those containing from 6 to 14 carbon atoms.

As examples of dicarboxylic acids, mention may be made of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

As examples of diamines, mention may be made of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl aminocyclohexyl)methane (BMACM) and 2,2-bis(3-methyl aminocyclohexyl)propane (BMACP), and para-aminodicyclohexylmethane (PACM), and isophoronediamine (IPDA), 2,6-bis(aminomethyl)norbornane (BAMN) and piperazine (Pip).

Advantageously, PA 4.12, PA 4.14, PA 4.18, PA 6.10, PA 6.12, PA 6.14, PA 6.18, PA 9.12, PA 10.10, PA 10.12, PA 10.14 and PA 10.18 blocks are used. In the notation PA X.Y, X represents the number of carbon atoms derived from the diamine residues and Y represents the number of carbon atoms derived from the diacid residues, as is conventional.

According to a second type, the polyamide blocks result from the condensation of one or more α,ω-aminocarboxylic acids and/or of one or more lactams containing from 6 to 12 carbon atoms in the presence of a dicarboxylic acid containing from 4 to 12 carbon atoms or of a diamine. As examples of lactams, mention may be made of caprolactam, oenantholactam and lauryllactam. As examples of α,ω-aminocarboxylic acids, mention may be made of aminocaproic acid, 7-aminoheptanoic acid, 11-aminoundecanoic acid and 12-aminododecanoic acid.

Advantageously, the polyamide blocks of the second type are made of polyamide 11, polyamide 12 or polyamide 6. In the notation PA X, X represents the number of carbon atoms derived from amino acid residues.

According to a third type, the polyamide blocks result from the condensation of at least one α,ω-aminocarboxylic acid (or a lactam), at least one diamine and at least one dicarboxylic acid.

In this case, the polyamide PA blocks are prepared by polycondensation:

of the linear aliphatic or aromatic diamine(s) containing X carbon atoms;
of the dicarboxylic acid(s) containing Y carbon atoms; and
of the comonomer(s) {Z}, chosen from lactams and α,ω-aminocarboxylic acids containing Z carbon atoms and equimolar mixtures of at least one diamine containing X1 carbon atoms and of at least one dicarboxylic acid containing Y1 carbon atoms, (X1, Y1) being different from (X,Y),
said comonomer(s) {Z} being introduced in a weight proportion ranging up to 50%, preferably up to 20%, even more advantageously up to 10% relative to the total amount of polyamide-precursor monomers;
in the presence of a chain limiter chosen from dicarboxylic acids; advantageously, the dicarboxylic acid containing Y carbon atoms is used as chain limiter, which is introduced in excess relative to the stoichiometry of the diamine(s).

According to one variant of this third type, the polyamide blocks result from the condensation of at least two α,ω-aminocarboxylic acids or of at least two lactams containing from 6 to 12 carbon atoms or of one lactam and one aminocarboxylic acid not having the same number of carbon atoms, in the optional presence of a chain limiter. As examples of aliphatic α,ω-aminocarboxylic acids, mention may be made of aminocaproic acid, 7-aminoheptanoic acid, 11-aminoundecanoic acid and 12-aminododecanoic acid. As examples of lactams, mention may be made of caprolactam, oenantholactam and lauryllactam. As examples of aliphatic diamines, mention may be made of hexamethylenediamine, dodecamethylenediamine and trimethylhexamethylenediamine. As examples of cycloaliphatic diacids, mention may be made of 1,4-cyclohexanedicarboxylic acid. As examples of aliphatic diacids, mention may be made of butanedioic acid, adipic acid, azelaic acid, suberic acid, sebacic acid, dodecanedicarboxylic acid, dimerized fatty acids (these dimerized fatty acids preferably have a dimer content of at least 98%; they are preferably hydrogenated; they are sold under the brand name Pripol by the company Unichema, or under the brand name Empol by the company Henkel) and α,ω-diacid polyoxyalkylenes. As examples of aromatic diacids, mention may be made of terephthalic acid (T) and isophthalic acid (I). As examples of cycloaliphatic diamines, mention may be made of the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM). The other diamines commonly used may be isophoronediamine (IPDA), 2,6-bis(aminomethyl)norbornane (BAMN) and piperazine.

As examples of polyamide blocks of the third type, mention may be made of the following:

PA 6.6/6, in which 6.6 denotes hexamethylenediamine units condensed with adipic acid and 6 denotes units resulting from the condensation of caprolactam;
PA 6.6/6.10/11/12 in which 6.6 denotes hexamethylenediamine condensed with adipic acid; 6.10 denotes hexamethylenediamine condensed with sebacic acid; 11 denotes units resulting from the condensation of aminoundecanoic acid; and 12 denotes units resulting from the condensation of lauryllactam.

The notations PA X/Y, PA X/Y/Z, etc. relate to copolyamides in which X, Y, Z, etc. represent homopolyamide units as described above.

Advantageously, said at least one polyamide block of the copolymer(s) used in the composition of the invention comprises at least one of the following polyamide monomers: 6, 11, 12, 5.4, 5.9, 5.10, 5.12, 5.13, 5.14, 5.16, 5.18, 5.36, 6.4, 6.9, 6.10, 6.12, 6.13, 6.14, 6.16, 6.18, 6.36, 10.4, 10.9, 10.10, 10.12, 10.13, 10.14, 10.16, 10.18, 10.36, 10. T, 12.4, 12.9, 12.10, 12.12, 12.13, 12.14, 12.16, 12.18, 12.36, 12.T and mixtures or copolymers thereof; and preferably chosen from the following polyamide monomers: 6, 11, 12, 6.10, 10.10, 10.12, and mixtures or copolymers thereof.

Preferably, the polyamide blocks comprise at least 30%, preferably at least 50%, preferably at least 75%, preferably 100%, by weight of PA 11 or PA 12, relative to the total weight of polyamide blocks.

The polyether blocks may represent 50% to 80% by weight of the copolymer bearing polyamide and polyether blocks.

The polyether blocks may notably be blocks derived from PEG (polyethylene glycol), i.e. consisting of ethylene oxide units, and/or blocks derived from PPG (propylene glycol), i.e. consisting of propylene oxide units, and/or blocks derived from PO3G (polytrimethylene glycol), i.e. consisting of polytrimethylene glycol ether units, and/or blocks derived from PTMG, i.e. consisting of tetramethylene glycol units, also known as polytetrahydrofuran. The PEBA copolymers may comprise in their chain several types of polyethers, the copolyethers possibly being in block or statistical form.

In the context of the present invention, it is preferable for the PEBA copolymer to comprise PEG blocks, optionally combined with PPG blocks, PO3G blocks, and/or PTMG blocks.

Thus, according to certain embodiments, the PEBA copolymer comprises PEG blocks. These blocks may be present in the PEBA copolymer in a content of from 50% to 80%, preferably from 55% to 75%, and even more preferably from 60% to 70% by weight relative to the weight of the copolymer. For example, this content may be from 50% to 55%; or from 55% to 60%; or from 60% to 65%; or from 65% to 70%; or from 70% to 75%; or from 75% to 80% by weight relative to the weight of the copolymer.

Advantageously, the copolymer of the composition may also comprise at least one polyether other than PEG, chosen from polypropylene glycol (PPG), polytrimethylene glycol (PO3G), polytetramethylene glycol (PTMG) and mixtures thereof.

Use may also be made of blocks obtained by oxyethylation of bisphenols, for instance bisphenol A. The latter products are described in patent EP 613 919.

The polyether blocks may also consist of ethoxylated primary amines. As examples of ethoxylated primary amines, mention may be made of the products of formula:

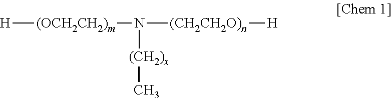

in which m and n are between 1 and 20, and x is between 8 and 18. These products are commercially available under the brand name Noramox® from the company Arkema and under the brand name Genamin® from the company Clariant.

The flexible polyether blocks may comprise polyoxyalkylene blocks bearing NH₂ chain ends, such blocks being able to be obtained by cyanoacetylation of α,ω-dihydroxylated aliphatic polyoxyalkylene blocks referred to as polyetherdiols. More particularly, use may be made of the Jeffamine products (for example Jeffamine® D400, D2000, ED 2003, XTJ 542, which are commercial products from the company Huntsman, also described in patents JP2004346274, JP2004352794 and EP1482011).

The polyether diol blocks are either used in unmodified form and copolycondensed with polyamide blocks bearing carboxylic end groups, or they are aminated to be converted into polyetherdiamines and condensed with polyamide blocks bearing carboxylic end groups. The general method for the two-step preparation of PEBA copolymers containing ester bonds between the PA blocks and the PE blocks is known and is described, for example, in French patent FR 2 846 332. The general method for the preparation of the PEBA copolymers of the invention containing amide bonds between the PA blocks and the PE blocks is known and is described, for example, in European patent EP 1 482 011. The polyether blocks may also be mixed with polyamide precursors and a chain-limiting diacid to prepare polymers containing polyamide blocks and polyether blocks having randomly distributed units (one-step process).

Needless to say, the name PEBA in the present description of the invention relates not only to the Pebax® products sold by Arkema, to the Vestamid® products sold by Evonik® and to the Grilamid® products sold by EMS, but also to the Pelestat® type PEBA products sold by Sanyo or to any other PEBA from other suppliers.

Advantageously, the PEBA copolymers may contain polyamide blocks as PA 6, as PA 11, as PA 12, PA 6.12, as PA 6.6/6, as PA 10.10 and/or as PA 6.14, preferably PA 11 and/or PA 12 blocks; and polyether blocks as PEG.

PEBA copolymers that are particularly preferred in the context of the invention are copolymers including blocks from among:

PA 11 and derived from PEG;
PA 12 and derived from PEG;
PA 10.10 and derived from PEG;
PA 10.12 and derived from PEG;
PA 6.12 and derived from PEG;
PA 6 and derived from PEG.

Preferably, a PEBA copolymer that is preferred in the context of the invention is the copolymer including PA 11 or PA 12 blocks and blocks derived from PEG.

In other words, the copolymer according to the invention may comprise at least one PEBA chosen from: PA 6-PEG, PA 11-PEG, PA 12-PEG, PA 10.10-PEG, PA 10.12-PEG, PA 6.12-PEG and mixtures thereof; and preferably comprises, or better still is PA11-PEG or PA12-PEG.

Whereas the block copolymers described above generally comprise at least one polyamide block and at least one polyether block, the present invention also covers all the copolymers comprising two, three, four (or even more) different blocks chosen from those described in the present description, provided that these blocks include at least polyamide and polyether blocks.

Advantageously, the copolymer alloy according to the invention comprises a block segmented copolymer comprising three different types of blocks (referred to as “triblock” in the present description of the invention), which result from the condensation of several of the blocks described above. Said triblock is preferably chosen from copolyetheresteramides, copolyetheramideurethanes, in which:

the mass percentage of polyamide blocks is greater than 10%;
the mass percentage of PEG blocks is greater than 50%;
relative to the total mass of triblock.

The number-average molar mass of the polyamide blocks in the PEBA copolymer is preferably from 400 to 20 000 g/mol, more preferentially from 500 to 10 000 g/mol and even more preferentially from 200 to 2000 g/mol. In certain embodiments, the number-average molar mass of the polyamide blocks in the PEBA copolymer is from 400 to 1000 g/mol, or from 1000 to 1500 g/mol, or from 1500 to 2000 g/mol, or 2000 to 2500 g/mol, or 2500 to 3000 g/mol, or 3000 to 3500 g/mol, or 3500 to 4000 g/mol, or 4000 to 5000 g/mol, or from 5000 to 6000 g/mol, or from 6000 to 7000 g/mol, or from 7000 to 8000 g/mol, or from 8000 to 9000 g/mol, or from 9000 to 10 000 g/mol, or from 10 000 to 11 000 g/mol, or from 11 000 to 12 000 g/mol, or from 12 000 to 13 000 g/mol, or from 13 000 to 14 000 g/mol, or from 14 000 to 15 000 g/mol, or from 15 000 to 16 000 g/mol, or from 16 000 to 17 000 g/mol, or from 17 000 to 18 000 g/mol, or from 18 000 to 19 000 g/mol, or from 19 000 to 20 000 g/mol.

The number-average molar mass of the polyether blocks is preferably from 100 to 6000 g/mol, more preferentially from 200 to 3000 g/mol. In certain embodiments, the number-average molar mass of the polyether blocks is from 100 to 200 g/mol, or from 200 to 500 g/mol, or from 500 to 800 g/mol, or from 800 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 4500 g/mol, or from 4500 to 5000 g/mol, or from 5000 to 5500 g/mol, or from 5500 to 6000 g/mol.

The number-average molar mass is set by the content of chain limiter. It may be calculated according to the equation:

Mₙ=nₘₒₙₒₘₑᵣ×MW_{repeating unit}/n_{chain limiter}+MW_{chain limiter}

In this formula, nₘₒₙₒₘₑᵣ represents the number of moles of monomer, n_{chain limiter} represents the number of moles of limiter (for example diacid) in excess, MW_{repeating unit} represents the molar mass of the repeating unit, and MW_{chain limiter} represents the molar mass of the limiter (for example diacid) in excess.

The number-average molar mass of the polyamide blocks and of the polyether blocks may be measured before the copolymerization of the blocks by gel permeation chromatography (GPC).

The mass ratio of the polyamide blocks relative to the polyether blocks of the PEBA copolymer may notably be from 0.1 to 20. This mass ratio may be calculated by dividing the number-average molar mass of the polyamide blocks by the number-average molar mass of the polyether blocks.

Thus, the mass ratio of the polyamide blocks relative to the polyether blocks of the PEBA copolymer may be from 0.1 to 0.2; or from 0.2 to 0.3; or from 0.3 to 0.4; or from 0.4 to 0.5; or from 0.5 to 1; or from 1 to 2; or from 2 to 3; or from 3 to 4; or from 4 to 5; or from 5 to 7; or from 7 to 10; or from 10 to 13; or from 13 to 16; or from 16 to 19; or from 19 to 20.

Ranges from 2 to 19 and more specifically from 4 to 10 are particularly preferred.

The PEBA copolymer is present in the composition in a content ranging from 2% to 15% and preferably from 5% to 15% by weight relative to the weight of the composition. For example, the PEBA copolymer may be present in the composition in a content of from 2% to 3%; or from 3% to 5%; or from 5% to 7%; or from 7% to 9%; or from 9% to 10%; or from 10% to 11%; or from 11% to 12%; or from 12% to 13%; or from 13% to 14%; or from 14% to 15% by weight relative to the weight of the composition.

The addition of said at least one PEBA copolymer to the PMMA may be performed via any process that is well known to those skilled in the art in the field of polymers, notably by dry mixing, or by kneading at a temperature above the glass transition temperature of the various polymers added, or by shearing at a temperature substantially equal to the fluidization temperature of the various polymers added, notably by calendering, by extrusion, or by mixing in solution.

Advantageously, the composition of the invention has dust repellency or antistatic properties, with a surface resistivity of less than or equal to 10¹⁴ ohm/m², and preferably from 10¹¹ to 10¹⁴ ohm/m², for example 10¹² to 10¹³ ohm/m².

Still advantageously, this composition does not require, and thus does not include, any organic salts.

Nevertheless, it is possible to incorporate an organic salt or an ionic liquid into the composition according to the invention, to further improve its dust repellency performance.

Thus, according to certain embodiments, the composition according to the invention may comprise from 0.1% to 10%, preferably from 0.1% to 5%, by weight of at least one organic salt in the molten state relative to the total weight of the composition.

The term “organic salts” means salts consisting of organic cations associated with inorganic or organic anions.

Said at least one organic salt can be added in the molten state, i.e. when the organic salt is at a temperature above its melting point. Preferably, said at least one organic salt has a melting point below 300° C., preferably below 200° C., preferably below 100° C. and is then advantageously an ionic liquid, preferably having a melting point below 30° C. Certain properties of ionic liquids are non-volatility (no diffusion of volatile organic compounds into the atmosphere), non-flammability (therefore easy to handle and store), stability at high temperature (up to 400° C. for some), good conductivity, and high stability with respect to water and oxygen.

The organic salt may comprise at least one cation comprising one or more of the following molecules: ammonium, sulfonium, pyridinium, pyrrolidinium, imidazolium, phosphonium, lithium, guanidinium, piperidinium, thiazolium, triazolium, oxazolium, pyrazolium, and mixtures thereof.

Furthermore, the organic salt may comprise at least one anion comprising one or more of the following molecules: imides, notably bis(trifluoromethanesulfonyl)imide (abbreviated as NTf₂⁻); borates, notably tetrafluoroborate (abbreviated as BF₄⁻); phosphates, notably hexafluorophosphate (abbreviated as PF₆⁻); phosphinates and phosphonates, notably alkyl phosphonates; amides, notably dicyanamide (abbreviated to DCA⁻); aluminates, notably tetrachloroaluminate (AlCl₄⁻), halides (such as bromide, chloride, iodide, etc.), cyanates, acetates (CH₃COO⁻), notably trifluoroacetate; sulfonates, notably methanesulfonate (CH₃SO₃⁻), trifluoromethanesulfonate; sulfates, notably ethyl sulfate, hydrogen sulfate, and mixtures thereof.

For the purposes of the invention, the term “organic salt” more particularly means any organic salt which is stable at the temperatures used during the synthesis of the block copolymer according to the invention. A person skilled in the art can refer to the data sheets for organic salts, which indicate the decomposition limit temperature of each organic salt.

As examples of organic salts that may be used in the context of the invention, mention may notably be made of organic salts based on ammonium cation, based on imidazolium cation or imidazolinium cation, based on pyridinium cation, based on dihydropyridinium cation, based on tetrahydropyridinium cation, based on pyrrolidinium cation, based on guanidine cation, based on phosphonium cation.

Organic salts based on ammonium cation combine, for example:

an N-trimethyl-N-propylammonium cation with a bis(trifluoromethanesulfonyl)imide anion;
an N-trimethyl-N-butylammonium or N-trimethyl-N-hexylammonium cation with an anion chosen from bromide, tetrafluoroborate, hexafluorophosphate, bis(trifluoromethanesulfonyl)imide;
an N-tributyl-N-methylammonium cation with an iodide, bis(trifluoromethanesulfonyl)imide or dicyanamide anion;
a tetraethylammonium cation with a tetrafluoroborate anion;
a (2-hydroxyethyl)trimethylammonium cation with a dimethylphosphate anion;
a bis(2-hydroxyethyl)ammonium cation with a trifluoroacetate anion;
an N,N-bis(2-methoxy)ethylammonium cation with a sulfamate anion;
an N,N-dimethyl(2-hydroxyethyl)ammonium cation with a 2-hydroxyacetate or trifluoroacetate anion;
an N-ethyl-N,N-dimethyl-2-methoxyethyl ammonium cation with a bis(trifluoromethylsulfonyl)imide anion;
an ethyldimethylpropylammonium cation and a bis(trifluoromethylsulfonyl)imide anion;
a methyltrioctylammonium cation and a bis(trifluoromethylsulfonyl)imide anion;
a methyltrioctylammonium cation and a trifluoroacetate or trifluoromethylsulfonate anion;
a tetrabutylammonium cation and a bis(trifluoromethylsulfonyl)imide anion;
a tetramethylammonium cation and a bis(oxalato(2-))-borate or tris(pentafluoroethyl)trifluorophosphate anion.

Mention may also be made of imidazole-based organic salts, such as disubstituted imidazoles, monosubstituted imidazoles, trisubstituted imidazoles; in particular those based on imidazolium cation or imidazolinium cation.

Mention may be made of organic salts based on imidazolium cation combining, for example:

an H-methylimidazolium cation with a chloride anion;
a 1-ethyl-3-methylimidazolium cation with a chloride, bromide, tetrafluoroborate, hexafluorophosphate, trifluoromethanesulfonate, bis(trifluoromethanesulfonyl)imide, tetrachloroaluminate, ethylphosphonate or methylphosphonate, methanesulfonate, ethylsulfate or ethylsulfonate anion;
a 1-butyl-3-methylimidazolium cation with a chloride, bromide, tetrafluoroborate, hexafluorophosphate, trifluoromethanesulfonate, bis(trifluoromethanesulfonyl)imide, tetrachloroaluminate, acetate, hydrogen sulfate, trifluoroacetate or methanesulfonate anion;
a 1,3-dimethylimidazolium cation with a methyl phosphonate anion;
a 1-propyl-2,3-dimethylimidazolium cation with a bis(trifluoromethanesulfonyl)imide anion;
a 1-butyl-2,3-dimethylimidazolium cation with a bis(trifluoromethanesulfonyl)imide tetrafluoroborate anion;
a 1-hexyl-3-methylimidazolium cation with a tetrafluoroborate, hexafluorophosphate or bis(trifluoromethanesulfonyl)imide anion;
a 1-octyl-3-methylimidazolium cation with a bis(trifluoromethanesulfonyl)imide anion;
a 1-ethanol-3-methylimidazolium cation with a chloride, bromide, tetrafluoroborate, hexafluorophosphate, bis(trifluoromethanesulfonyl)imide or dicyanamide anion.

Examples that may also be mentioned include organic salts based on pyridinium cation such as: N-butyl-3-methylpyridinium bromide, N-butylmethyl-4-pyridinium chloride, N-butylmethyl-4-pyridinium tetrafluoroborate, N-butyl-3-methylpyridinium chloride, N-butyl-3-methylpyridinium dicyanamide, N-butyl-3-methylpyridinium methylsulfate, 1-butyl-3-methylpyridinium tetrafluoroborate, N-butylpyridinium chloride, N-butylpyridinium tetrafluoroborate, N-butylpyridinium trifluoromethylsulfonate, 1-ethyl-3-hydroxymethylpyridinium ethylsulfate, N-hexylpyridinium bis(trifluoromethylsulfonyl)imide, N-hexylpyridinium trifluoromethansulfonate, N-(3-hydroxypropyl)pyridinium bis(trifluoromethylsulfonyl)imide, N-butyl-3-methylpyridinium trifluoromethanesulfonate, N-butyl-3-methylpyridinium hexafluorophosphate.

Examples that may also be mentioned include organic salts based on a pyrrolidinium cation such as: 1-butyl-1-methyl-1-pyrrolidinium chloride, 1-butyl-1-methylpyrrolidinium dicyanamide, 1-butyl-1-methyl-1-pyrrolidinium trifluoromethanesulfonate, 1-butyl-1-methyl-1-pyrrolidinium tris(pentafluoroethyl), 1-butyl-1-methylpyrrolidinium bis[oxalato(2-)]borate, 1-butyl-1-methylpyrrolidinium bis(trifluoromethylsulfonyl)imide, 1-butyl-1-methylpyrrolidinium dicyanamide, 1-butyl-1-methylpyrrolidinium trifluoroacetate, 1-butyl-1-methylpyrrolidinium trifluoromethanesulfonate, butyl-1-methyl-1-pyrrolidinium tris(pentafluoroethyl)trifluorophosphate, 1,1-dimethylpyrrolidinium iodide, 1-(2-ethoxyethyl)-1-methylpyrrolidinium bis(trifluoromethylsulfonyl)imide, 1-hexyl-1-methylpyrrolidinium bis(trifluoromethylsulfonyl)imide, 1-(2-methoxyethyl)-1-methylpyrrolidinium bis(trifluoromethylsulfonyl)imide, methyl-1-octyl-1-pyrrolidinium chloride, 1-butyl-1-methylpyrrolidinium bromide.

Mention may also be made of organic salts combining:

a 1-ethyl-1-methylpyrrolidinium cation with a bromide, tetrafluoroborate, hexafluorophosphate or trifluoromethanesulfonate anion;
a 1-butyl-1-methylpyrrolidinium cation with a chloride, bromide, tetrafluoroborate, hexafluorophosphate, trifluoromethanesulfonate, bis(trifluoromethanesulfonyl)imide, dicyanamide, acetate or hydrogen sulfate anion;
an N-propyl-N-methylpyrrolidinium cation with a bis(trifluoromethanesulfonyl)imide anion;
a 1-methyl-1-propylpiperidinium cation with a bis(trifluoromethanesulfonyl)imide anion.

Examples that may also be mentioned of organic salts based on a guanidine cation include guanidine trifluoromethylsulfonate, guanidine tris(pentafluoroethyl)trifluorophosphate and hexamethylguanidine tris(pentafluoroethyl)trifluorophosphate.

Mention may be made of organic salts based on a phosphonium cation such as trihexyl(tetradecyl)phosphonium bis[oxalato(2-)]borate; trihexyl(tetradecyl)phosphonium bis(trifluoromethylsulfonyl)imide; trihexyl(tetradecyl)phosphonium tris(pentafluoroethyl)trifluorophosphate.

The abovementioned list of organic salts and cations and anions which may be included in the composition of the organic salts that may be used according to the invention is given purely as examples and is not exhaustive or limiting.

Consequently, the addition of any other organic salt may, of course, be envisioned in the context of the invention, provided that the decomposition temperature of the organic salt is higher than the temperatures to which the composition according to the invention is susceptible to be exposed.

According to certain embodiments, the composition according to the invention also comprises at least one inorganic salt, i.e. an alkali metal salt or alkaline-earth metal salt, among which mention may notably be made of salts of alkali metals, such as lithium, sodium and potassium, and salts of alkaline-earth metals, such as magnesium and calcium; with organic acids (mono- or di-carboxylic acids containing 1 to 12 carbon atoms, for example formic acid, acetic acid, propionic acid, oxalic acid and succinic acid; sulfonic acids containing 1 to 20 carbons, for example methanesulfonic acid, p-toluenesulfonic acid and thiocyanic acid) or mineral acids (hydrohalic acids, for example hydrochloric acid, hydrobromic acid, perchloric acid, sulfuric acid and phosphoric acid). Mention may be made of potassium acetate, lithium acetate, lithium chloride, magnesium chloride, calcium chloride, sodium bromide, potassium bromide, magnesium bromide, lithium perchlorate, sodium perchlorate, or potassium perchlorate, potassium sulfate, potassium phosphate, potassium thiocyanate, and the like.

Among them, halides are preferred, preferably lithium chloride, sodium chloride, potassium chloride, potassium acetates and potassium perchlorates. The amount of inorganic salt may generally be from 0.001% to 3%, and preferably 0.01% to 2%, relative to the weight of the composition.

The composition according to the invention may also comprise one or more additives and/or adjuvants. These additives may be chosen from stabilizers, plasticizers, lubricants, organic or mineral fillers, reinforcers, dyes, pigments, nacres, antimicrobial agents, flame retardants, antistatic agents (although it is preferred that no antistatic agents other than those mentioned above be present), agents for modifying the viscosity of the copolymer, antioxidants, UV stabilizers, flame retardants, carbon black, carbon nanotubes, mineral or organic dyes, pigments, dyes, mold-release agents, foaming agents, impact-resistance agents, anti-shrinkage agents, flame retardants, nucleating agents, and/or any other additive or adjuvant already mentioned and well known to those skilled in the art in the field of thermoplastic polymers.

According to certain embodiments, the composition of the invention also comprises at least one agent for improving the surface conductivity, chosen from: hygroscopic agents; fatty acids; lubricants; metals; metal films; metal powders; metal nanopowders; aluminosilicates; amines, such as quaternary amines; esters; fibers; carbon black; carbon fibers; carbon nanotubes; polyethylene glycol; intrinsically conductive polymers, such as polyaniline, polythiophene or polypyrrole derivatives; masterbatches; and mixtures thereof.

The present invention also relates to the use of the composition according to the invention for the manufacture of at least a part of the following objects: industrial part, automotive part, safety accessory, sign, illuminated banner, signpost and advertising panel, display, engraving, furniture, store fitting, decoration, contact ball, dental prosthesis, ophthalmic implant, membrane for hemodialysis, optical fibers, art object, decoration, sculpture, lenses, notably camera lenses, disposable camera lenses, printing medium, notably a medium for direct printing with UV inks for photo board, window, panoramic roof, vehicle headlights, etc.

### EXAMPLES

The examples that follow illustrate the invention without limiting it.

The following compositions were prepared by blending PMMA polymers and PEBA copolymers.

The PMMA polymers used are unblended copolymers free of impact modifiers:

PMMA 1: advantageously consists of 89% of MMA and 11% of ethyl acrylate (EA) copolymer, the molar mass of which is between 70 000 g/mol and 80 000 g/mol, having a loss factor tan δ equal to 30;
PMMA 2: advantageously consists of 89% of MMA and 11% of ethyl acrylate (EA) copolymer, the molar mass of which is between 75 000 g/mol and 85 000 g/mol, having a loss factor tan δ equal to 15;
PMMA 3: advantageously consists of 99.4% of MMA and 0.6% of ethyl acrylate (EA) copolymer, the molar mass of which is between 75 000 g/mol and 85 000 g/mol, having a loss factor tan δ equal to 4.6;
PMMA 4: advantageously consists of 95% of MMA and 5% of methacrylic acid (MAA) copolymer, the molar mass of which is between 75 000 g/mol and 85 000 g/mol, having a loss factor tan δ equal to 3.7;
PMMA 5: advantageously consists of 94% of MMA and 6% of ethyl acrylate (EA) copolymer, the molar mass of which is between 110 000 g/mol and 120 000 g/mol, having a loss factor tan δ equal to 3.1.

The PEBA polymers used are as follows:

PEBA 1: PA11-PEG (40/60) with PA 11 blocks of number-average molar mass 1000 g/mol and PEG blocks of number average molar mass 1500 g/mol;
PEBA 2: PA12-PEG (50/50) with PA 12 blocks of number-average molecular mass 1500 g/mol and PEG blocks of number average molecular mass 1500 g/mol.

The loss factor tan δ of the PMMA polymer was measured using a parallel plate oscillatory rheometer at 220° C. by a frequency sweep test from 628 to 0.0628 rad/s with a strain amplitude of 2-15%, with 25 mm diameter plates; the value at 1 rad/s was taken as reference.

The Haze, the log surface resistivity (log SR), the Vicat point, and the impact strength were measured for various compositions. The results are given in the table below.

TABLE 1

| | | | Impact | Vicat |
|---|---|---|---|---|
| | Haze | | strength | point |
| Compositions | (%) | Log SR | (kJ/m²) | (° C.) |
| 90% PMMA 1 + 10% PEBA 1 | 1.5 | 11.9 | 18.7 | 91 |
| (invention) | | | | |
| 92% PMMA 2 + 8% PEBA 1 | 1.2 | 12 | 22.7 | 91 |
| (invention) | | | | |
| 90% PMMA 2 + 10% PEBA 1 | 1.5 | 12 | 22 | 91 |
| (invention) | | | | |
| 90% PMMA 2 + 10% PEBA 2 | 1.2 | 12 | 21.6 | 91 |
| (invention) | | | | |
| 90% PMMA 3 + 10% PEBA 1 | 1.1 | 13.1 | 23 | 102 |
| (comparative) | | | | |
| 90% PMMA 4 + 10% PEBA 1 | 1 | 13.4 | 24.4 | 97 |
| (comparative) | | | | |
| 90% PMMA 5 + 10% PEBA 1 | 1.2 | 12.6 | 28 | 98 |
| (comparative) | | | | |
| 100% PMMA 1 (control) | <0.5 | >14 | 18 | 93 |
| 100% PMMA 2 (control) | <0.5 | >14 | 19 | 90 |
| 100% PMMA 3 (control) | <0.5 | >14 | 20 | 108 |
| 100% PMMA 4 (control) | <0.5 | >14 | 20 | 116 |
| 100% PMMA 5 (control) | <0.5 | >14 | 22 | 101 |

The Haze of each composition was measured according to the standard ASTM D1003.

The surface resistivity was measured using the Sefelec M1500P machine equipped with the 8009 cell, under the following conditions:

### Ddp: 40 V;

Charging time before reading: 60 sec;
I/d ratio: 53.4.

No specific conditioning was performed.

The impact strength was measured according to the standard ISO 179/1eU.

The Vicat point was measured according to the standard ISO 306650.

It is found that the compositions according to the invention:

have improved antistatic or dust repellency properties relative to PMMA alone;
have improved impact strength relative to PMMA alone;
have good transparency properties;
have better antistatic or dust repellency properties than comparative compositions, for an equal PEBA content;
show less alteration of the Vicat point than PMMA alone, in comparison with comparative compositions, for an equal PEBA content.

1. A composition comprising:
from 85% to 98% by weight of poly(methyl methacrylate), relative to the weight of the composition, the poly(methyl methacrylate) having a loss factor tan δ, which is the ratio of the moduli G″ and G′ measured at a temperature of 220° C. and an angular frequency of 1 rad/sec, greater than or equal to 10; and
from 2% to 15% by weight of copolymer containing polyamide blocks and polyether blocks, relative to the weight of the composition.

2. The composition as claimed in claim 1, in which the poly(methyl methacrylate) comprises a methyl methacrylate (MMA) copolymer.

3. The composition as claimed in claim 2, in which the MMA copolymer comprises from 60% to 99.7% by weight of MMA and from 0.3% to 40% by weight of at least one monomer containing at least one ethylenic unsaturation that can copolymerize with MMA.

4. The composition as claimed in claim 1, in which the copolymer containing polyamide blocks and polyether blocks comprises polyethylene glycol (PEG), relative to the weight of the copolymer.

5. The composition as claimed in claim 4, in which the copolymer containing polyamide blocks and polyether blocks also comprises at least one polyether other than polyethylene glycol (PEG), chosen from polypropylene glycol (PPG), polytrimethylene glycol (PO3G), polytetramethylene glycol (PTMG) and mixtures thereof.

6. The composition as claimed in claim 1, in which the polyamide (PA) blocks of the copolymer containing polyamide blocks and polyether blocks are chosen from the following polyamide (PA) blocks: 6, 11, 12, 5.4, 5.9, 5.10, 5.12, 5.13, 5.14, 5.16, 5.18, 5.36, 6.4, 6.9, 6.10, 6.12, 6.13, 6.14, 6.16, 6.18, 6.36, 10.4, 10.9, 10.10, 10.12, 10.13, 10.14, 10.16, 10.18, 10.36, 10. T, 12.4, 12.9, 12.10, 12.12, 12.13, 12.14, 12.16, 12.18, 12.36, 12.T and mixtures or copolymers thereof.

7. The composition as claimed in claim 1, in which the polyamide blocks of the copolymer containing polyamide blocks and polyether blocks comprise at least 30% by weight of PA 11 or PA 12, relative to the total weight of polyamide blocks.

8. The composition as claimed in claim 1, in which the copolymer containing polyamide blocks and polyether blocks is chosen from the following copolymers: PA 6-PEG, PA 11-PEG, PA 12-PEG, PA 10.10-PEG, PA 10.12-PEG, PA 6.12-PEG and mixtures thereof.

9. The composition as claimed in claim 1, which is free of organic salt.

10. The use of the composition as claimed in claim 1, for the manufacture of at least a part of the following objects: industrial part, automotive part, safety accessory, sign, illuminated banner, signpost and advertising panel, display, engraving, furniture, store fitting, decoration, contact ball, dental prosthesis, ophthalmic implant, membrane for hemodialysis, optical fibers, art object, sculpture, camera lenses, disposable camera lenses, printing medium, window, and panoramic roof.
